(19) United States
(12) Patent Application Publication
(10) Pub. No.: US 2014/0186507 A1
(43) Pub. Date: Jul. 3, 2014

(54) DUAL CHAMBER BEVERAGE CONTAINER

(71) Applicant: Lawrence William Wales, Maplewood, MN (US)

(72) Inventor: Lawrence William Wales, Maplewood, MN (US)

(21) Appl. No.: 14/141,650

(22) Filed: Dec. 27, 2013

Related U.S. Application Data
(60) Provisional application No. 61/848,228, filed on Dec. 28, 2012.

(51) Int. Cl. A47J 43/27; A23L 2/00

(52) U.S. Cl. CPC A47J 43/27; A23L 2/00
USPC 426/519; 206/221

(57) ABSTRACT

A beverage container includes a first chamber having a bottom wall with a hole extending therethrough and adapted to hold a first liquid and a second chamber that mates with the first chamber and is adapted to hold a second liquid. A dispensing mechanism that dispenses at least a portion of the second liquid into the first chamber through the at least one hole includes a tube, a plunger located within the tube and a first check valve. The plunger is movable between a first position and a second position to fill the tube with at least a portion of the second liquid and is movable between the second position and the first position to expel the second liquid into the first chamber. The first check valve prevents the second liquid from entering back into the second chamber when the plunger is moved back into the first position.

### CROSS-REFERENCE TO RELATED APPLICATION

The present application is based on and claims the benefit of U.S. provisional patent application Ser. No. 61/848,228, filed Dec. 28, 2012, the content of which is hereby incorporated by reference in its entirety.

### BACKGROUND

Mixed drinks are beverages that include two or more ingredients. For example, a mixed alcoholic beverage can include at least one non-alcoholic beverage that is mixed with a distilled beverage. In another example, non-alcoholic beverages can include at least two different non-alcoholic beverages mixed together, such as a liquid concentrate that is mixed with water or soda.

The discussion above is merely provided for general background information and is not intended to be used as an aid in determining the scope of the claimed subject matter.

### SUMMARY

A beverage container includes a first chamber or reservoir, a second chamber or reservoir and a dispensing mechanism that dispenses at least a portion of a fluid from the first reservoir into the second reservoir. The dispensing mechanism includes a tube and a plunger located within the tube and being movable between a first position within the tube and a second position within the tube. The plunger is configured to intake the fluid from the first reservoir into the tube when the plunger is retracted into the second position and being configured to expel the fluid into the second reservoir when the plunger is pushed back into the first position. The dispensing mechanism further includes a first check valve that allows the fluid in the first reservoir to enter the tube when the plunger is retracted into the second position but prevent the fluid from entering back into the first reservoir when the plunger is pushed back into the first position and a second check valve that allows the fluid in the tube to be expelled into the second reservoir when the plunger is pushed back into the first position but prevents contents in the second reservoir from entering into the tube when the plunger is retracted into the second position.

A method of mixing a secondary fluid with a primary fluid in a beverage container is also provided. A beverage container is obtained that houses a primary reservoir that holds the primary fluid, a secondary reservoir that holds the secondary fluid and a syringe for transferring the secondary fluid into the primary fluid. The secondary fluid is dispensed into the primary fluid by pulling a plunger of the syringe from a first position in a tube to a second position in the tube to fill the tube with at least a portion of the secondary fluid, returning the plunger from the second position to the first position to expel the portion of the secondary fluid into the primary fluid, and a first check valve prevents the portion of the secondary fluid that filled the tube from returning back into the secondary reservoir.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 illustrates a side view of a beverage container according to one embodiment.

FIG. 2 is an exploded side view of the beverage container of FIG. 1.

FIG. 3 is a section view of the beverage container of FIG. 1 in a first position.

FIG. 4 is a section view of the beverage container of FIG. 1 in a second position.

FIG. 5 is an enlarged section view of the dispensing mechanism of the beverage container illustrated in FIG. 1.

FIG. 6 illustrates a side view of a beverage container according to another embodiment.

FIG. 7 is an exploded side view of the beverage container of FIG. 6.

FIG. 8 is a section view of the beverage container of FIG. 6 in a first position.

FIG. 9 is an enlarged section view of the dispensing mechanism of the beverage container illustrated in FIG. 6.

FIG. 10 is a section view of the beverage container of FIG. 6 in a second position

### DETAILED DESCRIPTION

Embodiments described herein include a beverage container having dual chambers that provide the function of mixing two separately contained fluids together to make a consumable mixed drink (i.e., a cocktail). For example, a liquid beverage, such as a liquid containing alcohol, can be contained in one of the chambers of the beverage container and another type of liquid beverage can be contained in the other chamber of the beverage container to then be mixed together when needed. Such a beverage container eliminates the need to carry several containers and makes the beverage container a self-contained, portable beverage mixer. Other exemplary uses include, but are not limited to, introducing a liquid neutralizing agent, such as iodine, stored in one of the chambers into a contaminated fluid, such as water that is contaminated with bacteria, which is stored in the other chambers. Another exemplary use includes introducing a portion of a liquid beverage stored in a second chamber into a first chamber so that the second chamber that contains the remaining portion of liquid beverage cannot be contaminated while the portion of the liquid beverage that was introduced into the first chamber can be consumed from the first chamber.

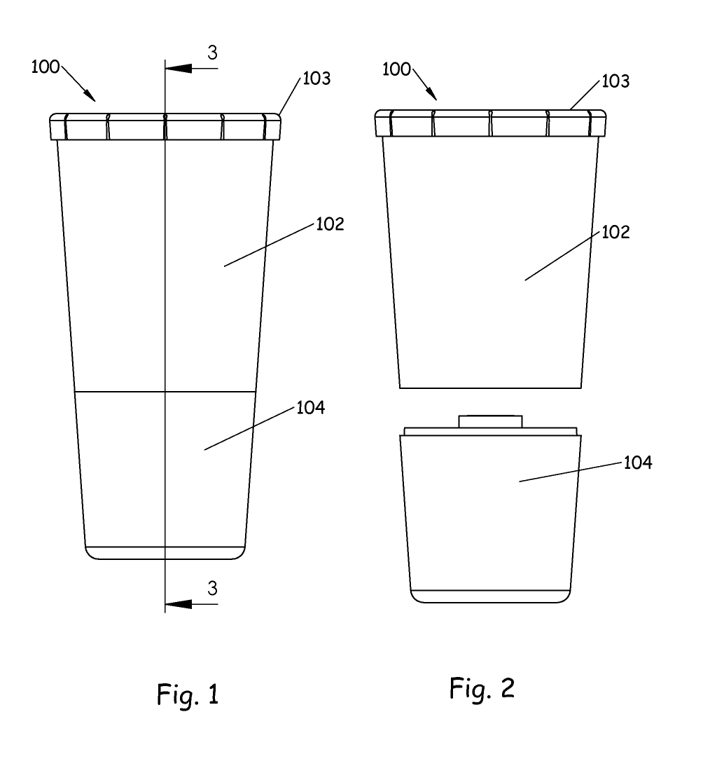

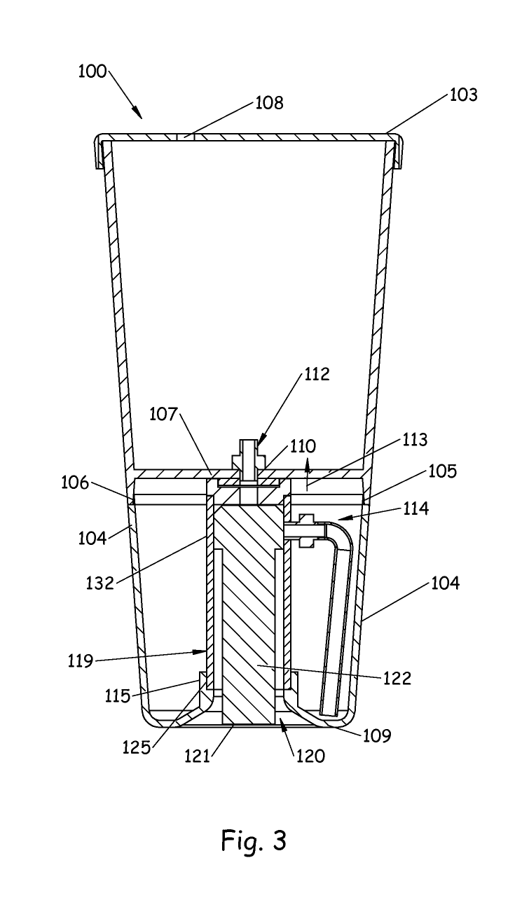

FIG. 1 illustrates a side view of a beverage container 100 according to one embodiment. Beverage container 100 includes two chambers or reservoirs—a first chamber or reservoir 102 and a second chamber or reservoir 104—that are assembled together to construct beverage container 100. In the embodiment illustrated in FIG. 1, first chamber 102 is located above second chamber 104. Beverage container 100 also includes a lid 103. Lid 103 engages with or disengages from a top of first chamber 102 by various mechanisms including being mated together using threads or being coupled together using a press-fit arrangement. In one embodiment, lid 103 includes a spout 108 (FIG. 3), which can give access to a fluid extraction element, such as a straw, or to access the fluid in first chamber 102 by pouring.

FIG. 2 is an exploded side view of beverage container 100 where first chamber 102 is disassembled from second chamber 104, but lid 103 is still engaged with the top of first chamber 102.

FIG. 3 is a section view of beverage container 100 taken through the line indicated in FIG. 1. In one embodiment and as illustrated in FIG. 3, first chamber 102 and second chamber 104 are connected together by, for example, mating internal threads, which would be located on the bottom of the housing of first chamber 102, with external threads, which would be located on the bottom of the housing of second chamber 104.

Beverage container 100 includes a dispensing mechanism 114 that dispenses at least a portion of a second liquid located in second chamber 104 into first chamber 102. A bottom wall 107 of first chamber 102 includes a centrally located through hole 110 through which is attached a portion of dispensing mechanism 114. More specifically, attached to through hole 110 is an upper check valve 112. Upper check valve 112 is fixedly attached, by a manufacturing procedure, such as, but not limited to, adhesive bonding, ultrasonically welding, solvent bonding, or molding. Upper check valve 112 is oriented in a manner such that liquid can flow through hole 110 in a direction 113 from second chamber 104 up into first chamber 102 and can prevent the flow of liquid through hole 110 in a direction opposite to direction 113. In other words, the orientation of upper check valve 112 prevents liquid from entering into second chamber 104 via gravity.

Remaining portions of dispensing mechanism 114 are located in second chamber 104 including dispensing mechanism 114 having a tubular plunger body assembly or syringe 119. Syringe 119 includes a tube 132 and a plunger 122 located and movable within tube 132. Portions of dispensing mechanism 114 are secured to a mounting block 115 that also defines a recessed pocket 120 in a bottom wall 109 of second chamber 104. Recessed pocket 120 allows the user to access the proximal handle end portion 121 of plunger 122 from the bottom of beverage container 100 to dispense liquid from second chamber 104 into first chamber 102. The dispensing mechanism 114 attaches into a counter bore 125 of mounting block 115.

FIG. 5 illustrates an enlarged section view of the portions of dispensing mechanism 114 that are located in second chamber 104. Dispensing mechanism 114 includes a plunger tube top 130 that is fixedly attached to tube 132 to create a tubular plunger body assembly or syringe 119. Plunger tube top 130 includes a through hole 134 used to allow liquid to escape through when pressurized. Tube 132 also has a through hole 136 located near the top end of tube 132.

Dispensing mechanism 114 also includes a lower check valve 138 fixedly attached to through hole 136 and extending within the wall of, but not beyond the inner lumen of tube 132. Lower check valve 138 is oriented such that the flow direction 140 allows liquid to flow into the inner lumen of tube 132 and is oriented to prevent liquid from flowing in a direction opposite from flow direction 140. A conduit 142 having an open end 143 is attached to lower check valve 138 to allow liquid contained in second chamber 104 to flow up conduit 142 in direction 144. Conduit 142 is positioned such that open end 143 is located near bottom wall 109 of second chamber 104.

Plunger tube top 130 is fixedly attached to a top end of tube 132. Plunger tube top 130 has a recessed pocket 146 that houses a washer 148. Washer 148 is a resilient material that protrudes from top of the tubular plunger body assembly 119 so that it compresses against bottom wall 107 of first chamber 102. Washer 148 compresses when first chamber 102 is completely attached to second chamber 104. The compression of washer 148 creates a liquid tight seal isolating first chamber 102 from second chamber 104. Therefore, when first chamber 102 is attached to second chamber 104, dispensing mechanism 114 is a sealed pressure vessel.

Plunger 122 has a distal end 150 that is made of a resilient material that is slightly oversized to create a seal within the lumen of tube 132, while a proximal handle end portion 121 of plunger 122 acts as the handle of plunger 122. When plunger 122 is in a first position (FIGS. 3 and 54) where it is fully pushed distally, proximal handle end portion 121 of plunger 122 will reside within recessed pocket 120 of second chamber 104. In the first position, distal end 150 of plunger 122 stops when it interferes with plunger tube top 130.

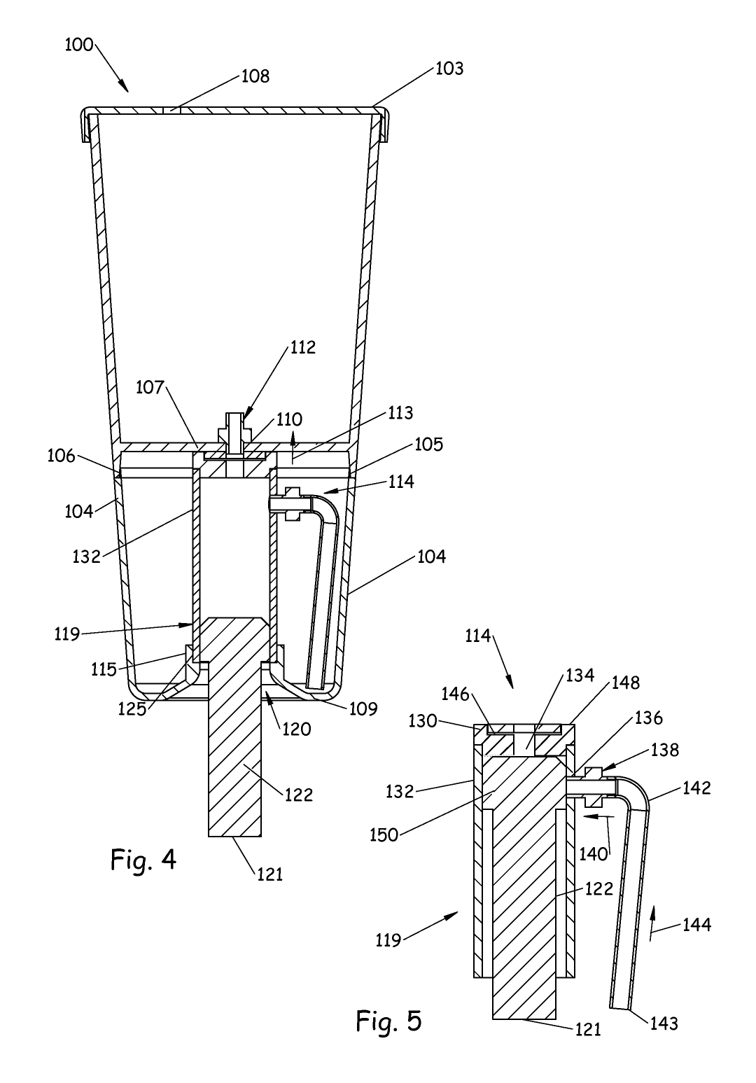

When a liquid or beverage is placed in second chamber 104 and open end 143 of conduit 142 is placed in the liquid or beverage in second chamber 104, pulling down or back on proximal handle end portion 121 of plunger 122 into a second position (FIG. 4) creates a vacuum within tube 132 that draws the liquid or beverage in second chamber 104 in direction 144 through conduit 142 in direction 140 and through check valve 138 into tube 132. Upon distal end 150 interfering with mounting block 115, plunger 122 has completed its full range of motion. The suction created from plunger 122 does not draw liquid from first chamber 102 due to the orientation of check valve 138, which prevents flow in a direction opposite from direction 140. Although FIG. 4 illustrates plunger 122 pulled in a full range of motion to interfere with mounting block 115, it should be realized that plunger 122 need not be. Pulling plunger 122 into a position that is at a distance that is less than a full range of motion is possible and would result in less of a quantity of liquid or beverage in second chamber 104 being drawn into tube 132.

Retracting or pushing plunger 122 back into the first position (FIGS. 3 and 5) within tube 132 so that distal end 150 again interferes with plunger tube top 130 pressurizes the liquid or beverage that was drawn into plunger tube 132 and dispenses or expels the liquid or beverage through hole 134 in plunger tube top 130 and also through check valve 112, which allows liquid to flow in direction 113 into first chamber 102. With plunger 122 fully seated back against plunger tube top 130, all the liquid from tube 132 is dispensed or expelled into top chamber 102 to mix with the liquid or beverage that is located in top chamber 102. Likewise, check valve 112 prevents the liquid or beverage located in top chamber from entering through hole 110, which keeps the liquid or newly mixed beverage contained in top chamber 102.

Beverage chamber 100 can be made from a variety of materials such as but not limited to, polymers, metals, metal alloys, etc. Processes such as plastic injection molding, blow molding or other conventional machining or manufacturing processes could be used to manufacture beverage chamber 100. Secondary manufacturing process, such as but not limited to adhesive bonding, welding, molding or a compression fit could be used to install and fixedly attach the check valves 112 and 138. Secondary processes to install dispensing mechanism 114 can also be used, such as but not limited to, adhesive bonding, welding, molding or compression fits.

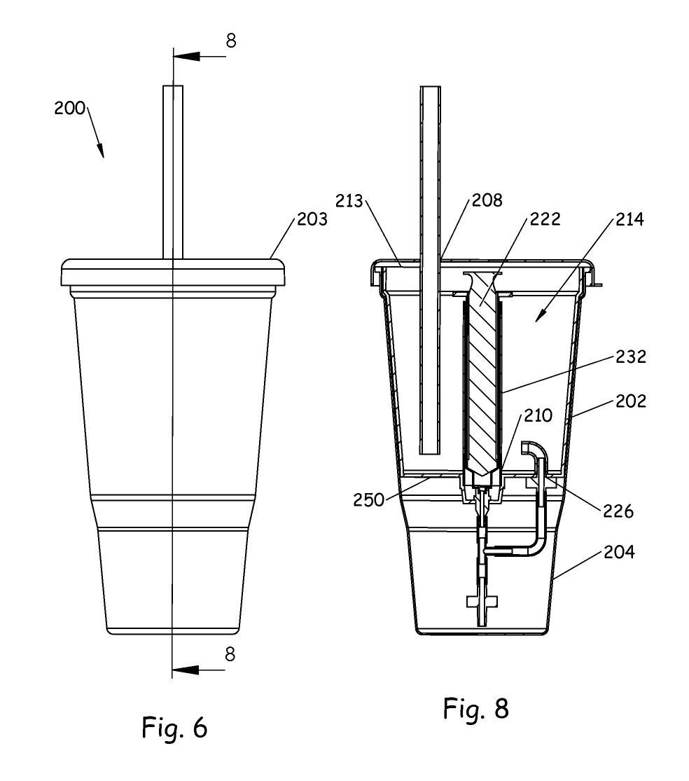

FIG. 6 illustrates a side view of a beverage container 200 according to another embodiment. Beverage container 200 includes two chambers or reservoirs—an internal chamber or second reservoir 202 and an external chamber or first reservoir 204—that are assembled together to construct beverage container 200. Beverage container 200 also includes a lid 203. Lid 203 is attached to or detached from a top 213 of external chamber 204 by various different mechanisms including being mated together using threads or being coupled together using a press-fit arrangement. In one embodiment, lid 203 includes a spout 208 (FIG. 8), which can give access to a fluid extraction element, such as a straw, or to access the fluid in internal chamber 202 by pouring.

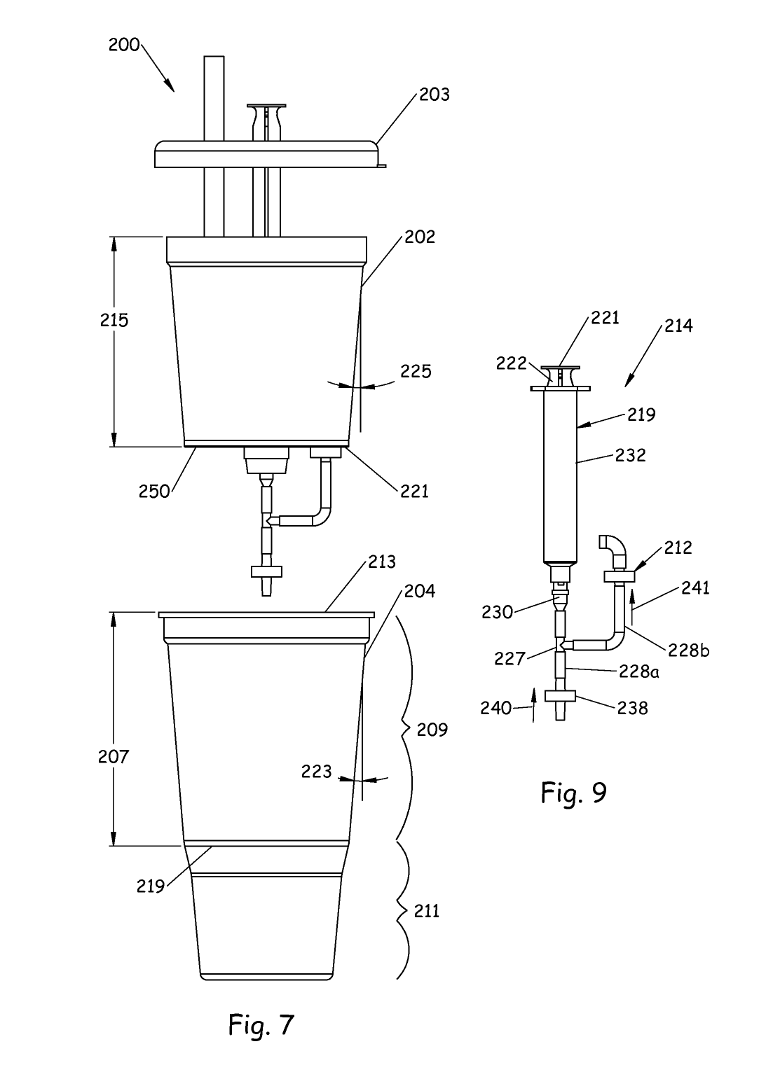

FIG. 7 is an exploded side view of beverage container 200 where internal chamber 202, external chamber 204 and lid 203 are disassembled from each other. As illustrated in FIG. 7, external chamber 204 includes an upper section 209 and a lower section 211. Lower section 211 is sized to fit in a standard cup holder or sized to have a standard cup size, while upper section 209 includes a height 207 that is greater than a height 215 of internal chamber 202. Both external chamber 204 and internal chamber 202 are tapered and include varying diameters. As illustrated in FIG. 7, the taper of upper section 209 of external chamber 204 is at an angle 223 relative to vertical and the taper of internal chamber 202 is at an angle 225 relative to vertical. Angle 223 is greater than angle 225 and the diameter at a bottom 219 of upper section 209 of external chamber 204 is less than or equal to the diameter at a bottom 221 of internal chamber 202.

FIG. 8 is a section view of beverage container 200 taken through the line indicated in FIG. 6. Internal chamber 202 fits within external chamber 204 and because the taper angle 225 of internal chamber 202 is smaller than the taper angle 223 of external chamber 204, the side wall of internal chamber 202 rests within first section 209 on the interior surface of the side wall of external chamber 204.

Beverage container 200 includes a dispensing mechanism 214 that dispenses at least a portion of a fluid located in external chamber 204 into internal chamber 202. A bottom wall 250 of internal chamber 202 includes a centrally located first through hole 210 through which a portion of dispenser mechanism 214 is attached. Bottom wall 250 of internal chamber 202 also includes a second through hole 226 located between first through hole 210 and the side wall of internal chamber 202 through which another portion of dispenser mechanism 214 is attached.

FIG. 9 illustrates an enlarged side view of dispensing mechanism 214. With reference to FIGS. 8 and 9, dispensing mechanism 214 includes a simple pump component or syringe 219 that has a plunger 222 that fits tightly in and is movable within a tube 232. Tube 232 is the portion of dispensing mechanism 214 that is fixedly attached, by a manufacturing procedure, such as, but not limited to, adhesive bonding, ultrasonically welding, solvent bonding, or molding, to first through hole 210. Tube 232 is attached to a connector 230, such as a luer fitting or luer taper. Connector 230 communicates fluid from external chamber 204 into tube 232 and from tube 232 into internal chamber 202.

Dispensing mechanism 214 also includes a first conduit 228a, a second conduit 228b, an upper check valve 212 and a lower check valve 238. First conduit 228a connects the fluid in external chamber or first reservoir 204 with syringe 219 and second conduit 228b connects the fluid drawn into syringe 219 with internal chamber or second reservoir 202. Each valve 212 and 238 acts as a one-way valve. Lower check valve 238 is connected to upper check valve 212 by first conduit 228a, a T-fitting 227 and a second conduit 228b. Lower check valve 238 is connected to connector 230 by first conduit 228a and T-fitting 227. Lower check valve 238 is interposed in first conduit 228a to allow liquid or beverage to flow in a direction 240 through connector 230 and fill the inner lumen of tube 232. Lower check valve 238 is also interposed in first conduit 228a to prevent or block liquid or beverage from flowing in an opposite direction from direction 240. Upper check valve 212 is interposed in second conduit 228b to allow liquid or beverage to flow in a direction 241 from T-fitting 227 into internal chamber 202 and prevents or blocks the flow of liquid or beverage in an opposite direction from direction 241.

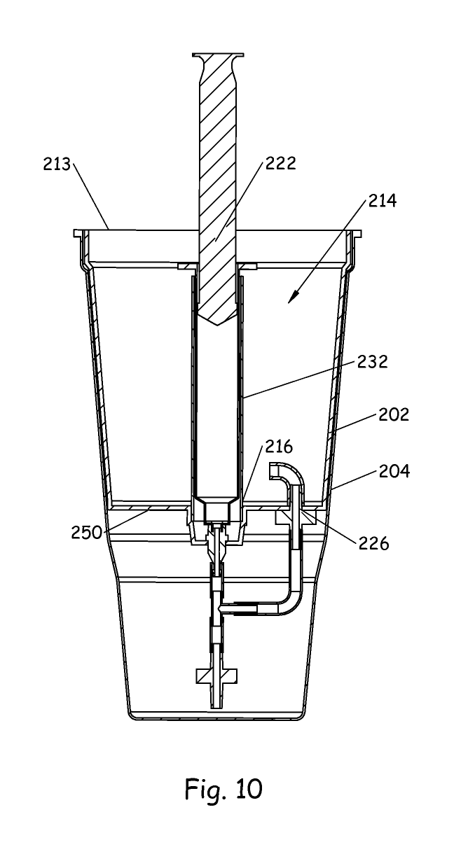

When a liquid or beverage is placed in external chamber 204, an open end of lower check valve 238 is placed in the liquid or beverage. To mix the separately contained beverages, a user removes lid 203, accesses a proximal handle end portion 221 of plunger 222 from a top of beverage container 100 and pulls back or up on handle end portion 221 from a first position (FIGS. 7 and 9) to a second position (FIG. 10) to create a vacuum within tube 232 that draws the liquid or beverage from the bottom container through check valve 238 to fill tube 232. With plunger 222 retracted as illustrated in FIG. 10, tube 232 is filled with a set amount of liquid or beverage from external chamber 203. It should be realized that plunger 222 (as illustrated in FIG. 10) need not be fully retracted. If less liquid or beverage located in external chamber 204 is desired to be mixed with the liquid or beverage located in internal chamber 202, then plunger 222 should be partially retracted to a point that is somewhere between fully plunged and fully retracted. After plunger 222 has been retracted to the desired location, a user pushes down on the plunger to pressurize the liquid or beverage that was taken in tube 232 and expels the liquid or beverage through upper check valve 212. The expelled liquid or beverage does not dispense through lower check valve 238 because it is oriented to block liquid or beverage from flowing in a direction opposite direction 240, but does enter through T-fitting 227 and through upper check valve 212 because upper check valve 2121 is oriented to allow liquid or beverage to flow in direction 241.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A beverage container comprising:
a first chamber that holds a first liquid and includes a bottom wall with at least one hole extending therethrough;
a second chamber that holds a second liquid;
a dispensing mechanism that dispenses at least a portion of the second liquid into the first chamber through the at least one hole, the dispensing mechanism comprising:
a tube;
a plunger located within the tube and being movable between a first position and a second position to fill the tube with at least a portion of the second liquid and being movable between the second position and the first position to expel the second liquid into the first chamber; and
a first check valve that prevents the second liquid from entering back into the second chamber when the plunger is moved back into the first position.

2. The beverage container of claim 1, wherein the dispensing mechanism further comprises a second check valve that prevents the first liquid in the first chamber from entering into the tube when the plunger is retracted into the second position.

3. The beverage container of claim 1, wherein the first chamber is located above at least a portion of the second chamber.

4. The beverage container of claim 2, wherein the first chamber comprises an interior chamber and the second chamber comprises an exterior chamber.

5. The beverage container of claim 4, wherein the exterior chamber comprises a height that is greater than a height of the interior chamber.

6. The beverage container of claim 4, wherein the exterior chamber comprises a side wall having a variable diameter that tapers at an angle relative to vertical that is greater than an angle relative to vertical that a side wall of the interior chamber tapers so that a bottom of the inner chamber contacts an interior surface of the side wall above a bottom of the exterior chamber.

7. The beverage container of claim 6, wherein the exterior chamber comprises an upper section and a lower section, the lower section being sized to fit into a standard cup holder.

8. The beverage container of claim 7, wherein the angle relative to vertical that the side wall of the interior chamber tapers is greater than the angle relative to vertical that the side wall of the exterior chamber tapers such that the bottom of the interior chamber contacts the interior surface of the side wall of the upper section of the exterior chamber.

9. The beverage container of claim 3, further comprising a lid that engages with a top of the first chamber.

10. The beverage container of claim 4, further comprising a lid that engages with a top of the exterior chamber.

11. A beverage container comprising:
a first reservoir;
a second reservoir;
a dispensing mechanism that dispenses at least a portion of a fluid from the first reservoir into the second reservoir, the dispensing mechanism comprising:
a tube;
a plunger located within the tube and being movable between a first position within the tube and a second position within the tube, wherein the plunger is configured to intake the fluid from the first reservoir into the tube when the plunger is retracted into the second position and being configured to expel the fluid into the second reservoir when the plunger is pushed back into the first position;
a first check valve that allows the fluid in the first reservoir to enter the tube when the plunger is retracted into the second position but prevent the fluid from entering back into the first reservoir when the plunger is pushed back into the first position; and
a second check valve that allows the fluid in the tube to be expelled into the second reservoir when the plunger is pushed back into the first position but prevents contents in the second reservoir from entering into the tube when the plunger is retracted into the second position.

12. The beverage container of claim 11, wherein the plunger is accessible from a top of the beverage container.

13. The beverage container of claim 11, wherein the plunger is accessible from a bottom of the beverage container.

14. The beverage container of claim 11, wherein the tube is located in a first hole that extends between the first reservoir and the second reservoir.

15. The beverage container of claim 14, wherein the dispensing mechanism further comprises a first conduit that connects the fluid in the first reservoir to the tube and a second conduit that connects the tube to the second reservoir through a second hole that extends between the first reservoir and the second reservoir.

16. The beverage container of claim 15, wherein the first check valve is interposed in the first conduit between the fluid in the first reservoir and the tube.

17. The beverage container of claim 16, wherein the second check valve is interposed in the second conduit between the tube and the second reservoir.

18. A method of mixing a secondary fluid with a primary fluid in a beverage container, the method comprising:
obtaining a beverage container that houses a primary reservoir that holds the primary fluid, a secondary reservoir that holds the secondary fluid and a syringe for transferring the secondary fluid into the primary fluid;
dispensing the secondary fluid into the primary fluid by:
pulling a plunger of the syringe from a first position in a tube to a second position in the tube to fill the tube with at least a portion of the secondary fluid;
returning the plunger from the second position to the first position to expel the portion of the secondary fluid into the primary fluid; and
wherein a first check valve prevents the portion of the secondary fluid that filled the tube from returning back into the secondary reservoir.

19. The method of claim 18, further comprising accessing the plunger of the syringe from a top of the beverage container.

20. The method of claim 18, further comprising accessing the plunger of the syringe from a bottom of the beverage container.
